(19) United States
(12) Patent Application Publication
(10) Pub. No.: US 2022/0281294 A1
(43) Pub. Date: Sep. 8, 2022

(54) SUN VISOR MASK HOLDER

(71) Applicant: Nefte Couttolenc, Salinas, CA (US)

(72) Inventor: Nefte Couttolenc, Salinas, CA (US)

(21) Appl. No.: 17/192,798

(22) Filed: Mar. 4, 2021

(51) Int. Cl. B60J 3/02; F16B 2/20

(52) U.S. Cl. CPC B60J 3/0204; F16B 2/20; B60Y 2200/11

(57) ABSTRACT

A sun visor mask holder includes an attachment device for attaching the sun visor mask holder to a sun visor. A mask holder holds a mask in a stretched out position. The mask holder includes base section that includes a first hook for holding a first end of the mask. A slider section includes a second hook for holding a second end of the mask. A slider knob allows the slider section to be adjusted with respect to the base section adjusting a distance between the first hook and the second hook to accommodate holding masks of different sizes.

### BACKGROUND

As a result of the threat of COVID-19, wearing masks or other face coverings is often advised or required to reduce viral transmission. It is estimated half of transmissions occur before COVID-19 symptoms are manifest, so wearing a mask can reduce the risk of unknowingly spreading the infection. Masks provide protection not only for those wearing the masks but also for others in the vicinity of the mask wearer.

Wearing a mask can be uncomfortable and provide hindrances to breathing freely. Therefore, it is common for masks to be removed when users are in not in public. Nevertheless, masks still need to be stored in places that are accessible quickly to a user who wants to enter a public space. It is common, therefore, for users to store one or more masks in their automobile, for example, placing their mask in the glove compartment or other storage area, or hanging their mask on the rear view mirror or nobs of the stereo.

### BRIEF DESCRIPTION OF THE DRAWINGS

FIG. 1 and FIG. 2 show a mask holder configured for use with a sun visor.

FIG. 3 show the mask holder shown in FIG. 1 and FIG. 2 attached to a sun visor of an automobile.

FIG. 4 and FIG. 5 show a mask stored using the mask holder shown in FIG. 3.

FIG. 6 show a mask stored using the mask holder shown in FIG. 3 adjusted to hold a different sized mask.

### DETAILED DESCRIPTION

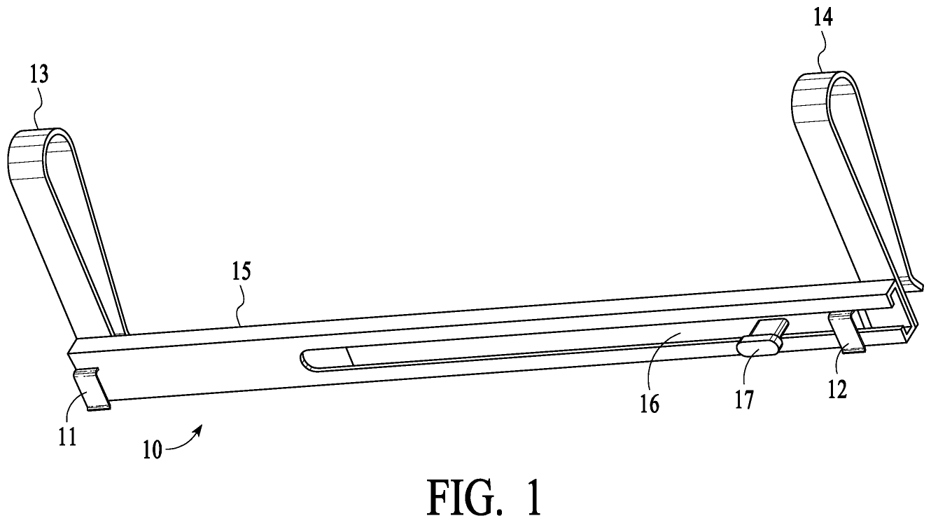

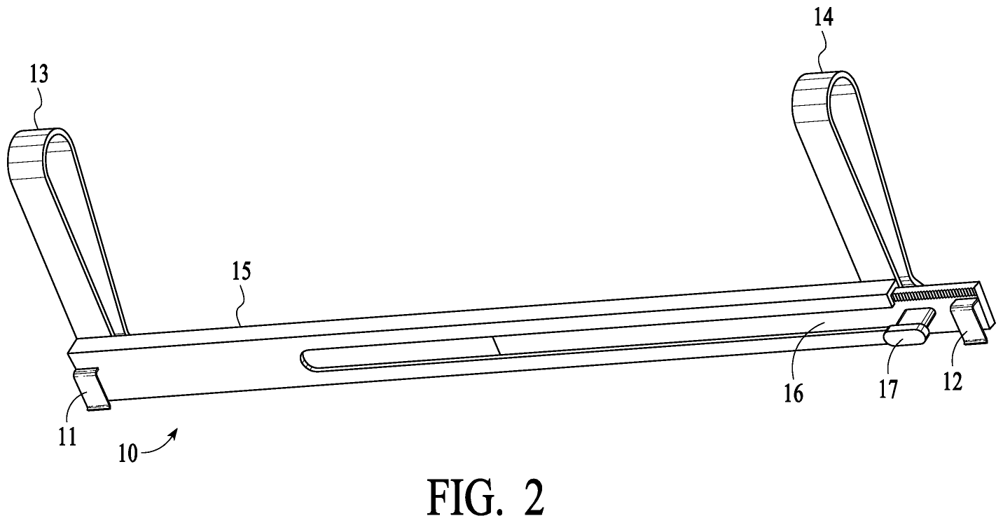

FIG. 1 and FIG. 2 show a mask holder 10 configured to use on a sun visor of an automobile. A clip 13 and a clip 14 are used to clip mask holder 10 to a sun visor. A hook 11 on a base section 15 and a hook 12 on a slider section 16 are used to hold a mask in a stretched out position. A knob 17 on slider section 16 is used to adjust the distance between hook 11 and hook 12 to optimize the hanging height of the mask.

For example, mask holder 10 is formed of plastic, wood, metal or some other material or combination of materials that are rigid or semi-rigid. For example, slider section 16 is held in position relative to base section using interaction of teeth between base section 15 and slider section 16, as illustrated in FIG. 2. Alternatively, slider section 16 is held in position relative to base section using friction between base section 15 and slider section 16, using springs connected to both slider section 16 and abase section 15 or some other mechanism that resists slider section 16 from sliding with respect base section 15 when a mask is mounted on mask holder 10, yet still allows slider section 16 and base section 15 to be adjustable to accommodate different mask sizes.

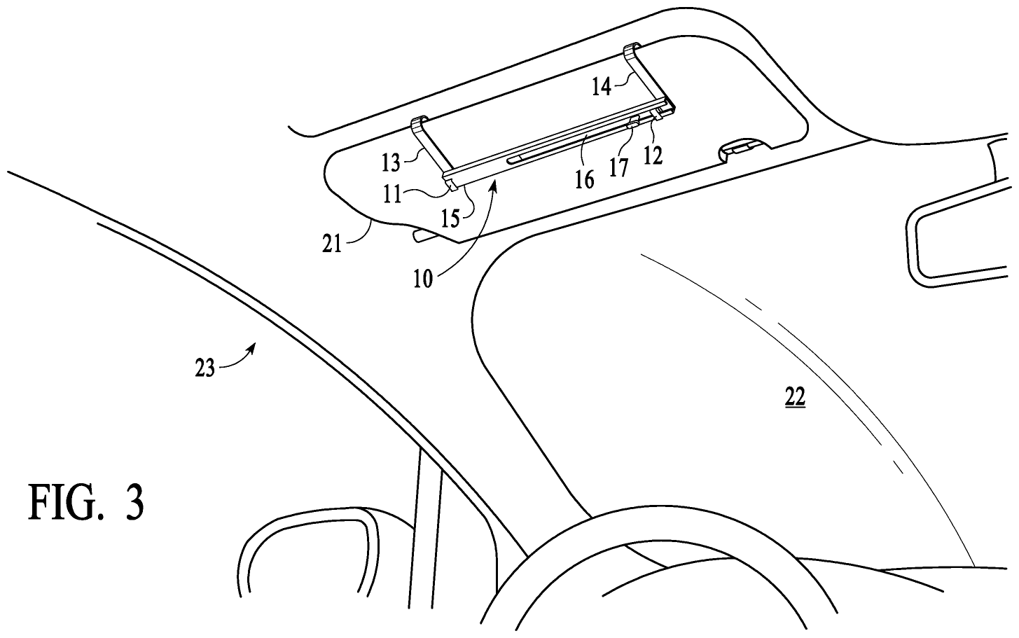

FIG. 3 show mask holder 10 attached to a sun visor 21 within an automobile 23. Clip 13 and clip 14 are used to attach mask holder 10 to sun visor 21. Alternatively, mask holder 10 may be permanently attached to sun visor 21 using an adhesive, screws, stables or some other mechanism that permanently attached mask holder 10 to sun visor 21, eliminating the need to include claim 13 and clip 14 as part of mask holder 10. Alternatively, mask holder 10 can be integrated as part of sun visor 21, likewise eliminating the need to include claim 13 and clip 14 as part of mask holder 10

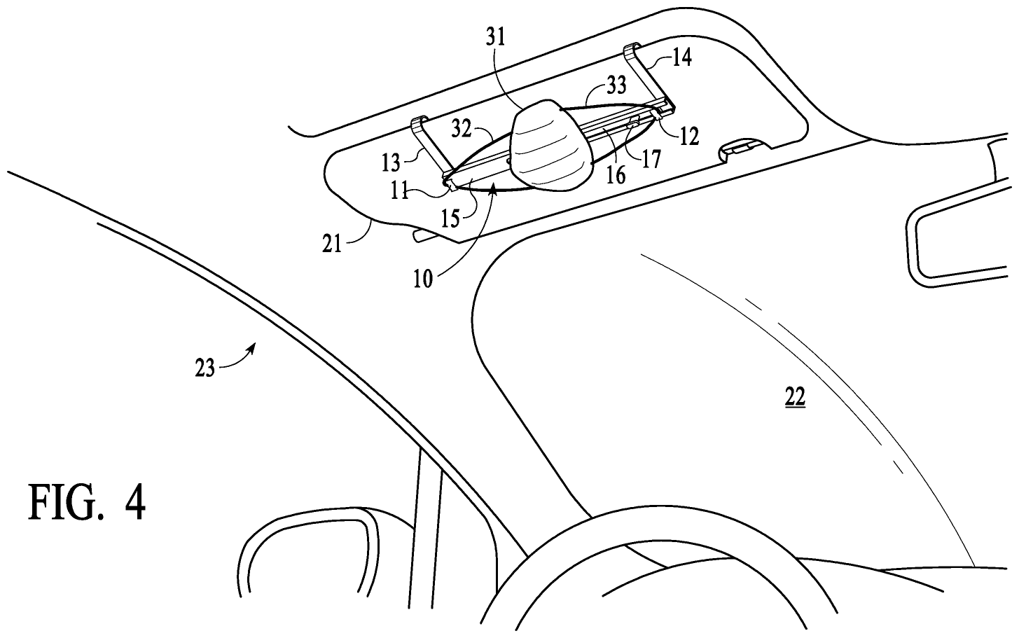

FIG. 4 shows a mask 31 mounted on mask holder 10 with sun visor 21 in an up/storage position. An ear loop 32 of mask 31 is placed over hook 11. An ear loop 33 of mask 31 is placed over hook 12. Knob 17 has been used to adjust the distance between hook 11 and hook 12 so that mask 31 is in a stretched out position so that mask 31 does not droop or otherwise interfere with the vision of the driver of automobile 23.

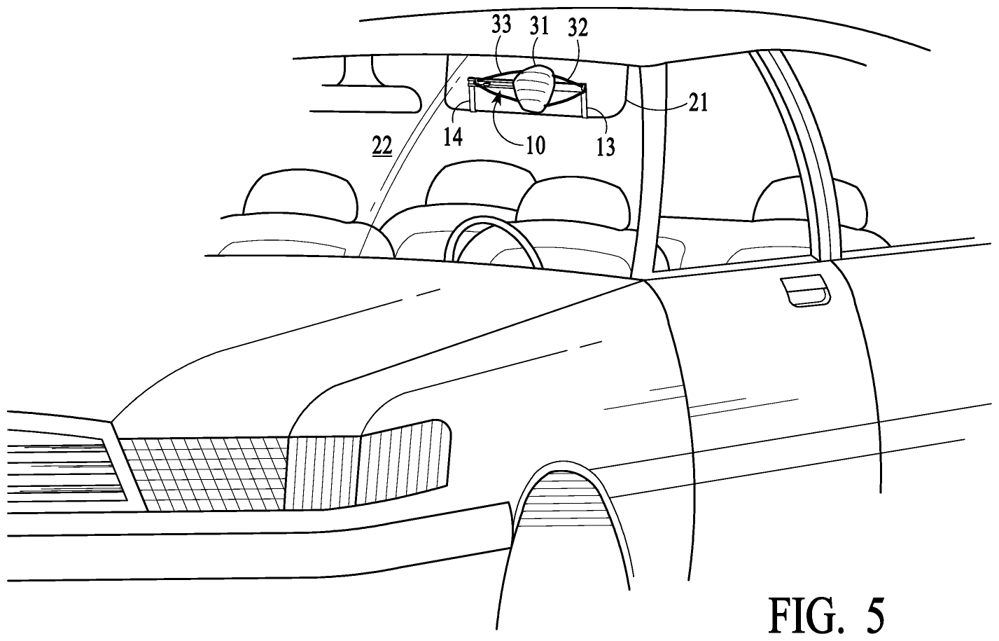

FIG. 5 shows mask 31 mounted on mask holder 10 when sun visor 21 is in a down or sun blocking position. In the down or sun blocking position, mask 31 faces a windshield 22 of automobile 23. When sun visor 21 is in the down or sun blocking position, mask 31 faces the windshield. This allows sunlight to reach mask 31, which may contribute to sterilization of mask 31 from light sensitive viruses.

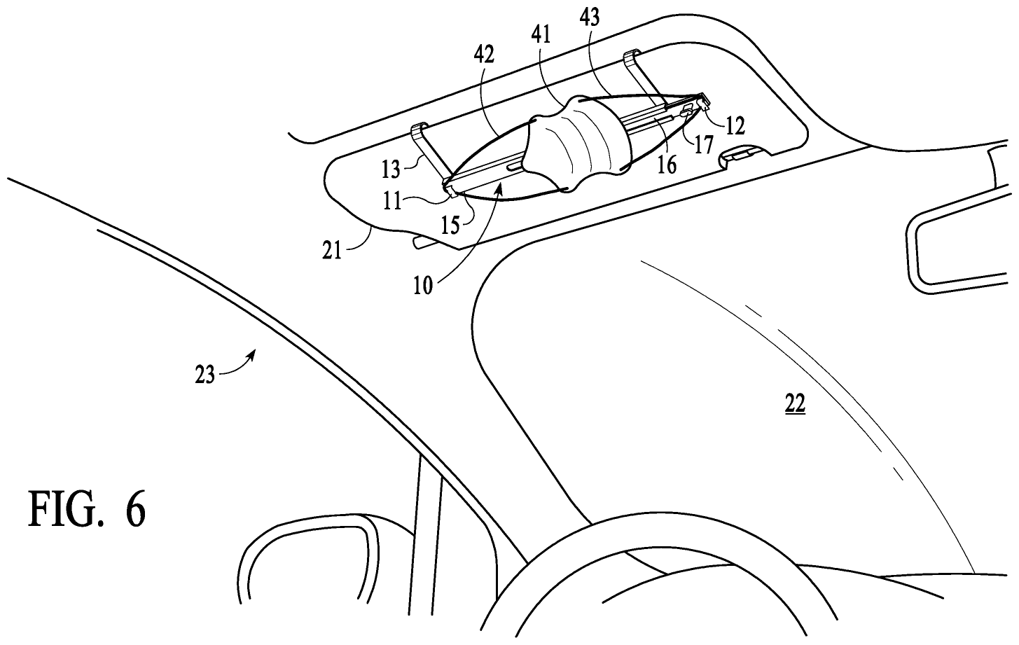

FIG. 6 shows a mask 41 mounted on mask holder 10 with sun visor 21 in an up/storage position. An ear loop 42 of mask 41 is placed over hook 11. An ear loop 43 of mask 41 is placed over hook 12. Knob 17 has been used to adjust the distance between hook 11 and hook 12 so that mask 41 so that mask 41 is in a stretched out position so that mask 41 does not droop or otherwise interfere with the vision of the driver of automobile 23. This accommodates mounting of mask 41 on mask holder 10 even though the hook 11 and hook 12 have to be further apart to hold mask 41 than when hook 11 and hook 12 are used to hold mask 31.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A sun visor mask holder comprising:
an attachment device for attaching the sun visor mask holder to a sun visor;
a mask holder that holds a mask in a stretched out position, the mask holder including:
a base section including a first hook for holding a first end of the mask,
a slider section including:
a second hook for holding a second end of the mask, and
a slider knob that allows the slider section to be adjusted with respect to the base section adjusting a distance between the first hook and the second hook to accommodate holding masks of different sizes.

2. A sun visor mask holder as in claim 1, wherein the attachment device is configured to hold the sun visor mask holder below the sun visor when the sun visor is in a closed position and to hold the sun visor mask holder towards a windshield of an automobile when the sun visor is in an open position.

3. A sun visor mask holder as in claim 1, wherein the attachment device includes two clips sized to clip the sun visor mask holder to the sun visor.

4. A sun visor mask holder as in claim 1, wherein the attachment device permanently affixes the sun visor mask holder to the sun visor.

5. A sun visor mask holder as in claim 1, wherein the slider section is held in position relative the base section using interaction of teeth between the base section and the slider section.

6. A sun visor mask holder comprising:
an attachment device for attaching the sun visor mask holder to a sun visor;
a mask holder that holds a mask in a stretched out position, the mask holder including:
a base section including a first hook for holding a first end of the mask, and
an adjustable section including:
a second hook for holding second end of the mask,
an adjustment mechanism that allows adjustment of a distance between the first hook and the second hook to accommodate holding masks of different sizes.

7. A sun visor mask holder as in claim 6, wherein the attachment device is configured to hold the sun visor mask holder below the sun visor when the sun visor is in a closed position and to hold the sun visor mask holder towards a windshield of an automobile when the sun visor is in an open position.

8. A sun visor mask holder as in claim 6, wherein the attachment device includes two clips sized to clip the sun visor mask holder to the sun visor.

9. A sun visor mask holder as in claim 6, wherein the attachment device permanently affixes the sun visor mask holder to the sun visor.

10. A sun visor mask holder as in claim 6, wherein the adjustable section includes:
a slider mechanism attached to the second hook for holding the second end of the mask, the slider mechanism including a slider knob serves as a user interface that allows adjustment of the distance between the first hook and the second hook.

11. A sun visor mask holder as in claim 6, wherein the adjustable section is held in position relative the base section using interaction of teeth between the base section and the adjustable section.
